(19) United States
(12) Patent Application Publication
(10) Pub. No.: US 2026/0352959 A1
(43) Pub. Date: Nov. 5, 2026

(54) Bitrate Based Exposure Factorization for Image and Video Processing

(71) Applicant: Google LLC, Mountain View, CA (US)

(72) Inventors: Navinprashath Rameswari Rajagopal, Mountain View, CA (US); Gaurav Malik, Sunnyvale, CA (US); Ruben Manuel Velarde, Chula Vista, CA (US); Szepo Robert Hung, Austin, TX (US)

(21) Appl. No.: 19/478,314

(22) PCT Filed: Apr. 24, 2023
(86) PCT No.: PCT/US2023/019582

§ 371 Date: Oct. 24, 2025

(51) Int. Cl. H04N 23/73; H04N 19/137; H04N 19/146; H04N 19/154

(52) U.S. Cl. CPC H04N 23/73; H04N 19/137; H04N 19/146; H04N 19/154

(57) ABSTRACT

A computer-implemented method for dynamically adjusting automatic exposure settings for a media content capturing device is described. The method involves determining, by a media content processing component for processing media content, an exposure time, a digital gain, and a bitrate for processing the media content. The method also involves adjusting, based on the bitrate, an amount of motion blur, a level of image noise, or both, by updating one or more of the exposure time or the digital gain, wherein the adjusting, when applied to the media content, reduces one or more image degradations associated with the media content. The method additionally involves processing the media content based on the one or more of the updated exposure time or the updated digital gain.

### BACKGROUND

Many modern computing devices, including mobile phones, personal computers, and tablets, include media content capturing devices, such as still and/or video cameras. The media content capturing devices can capture images and/or video, such as images and/or video that include people, animals, landscapes, and/or objects. Some media content capturing devices are configured with automatic exposure settings.

### SUMMARY

The present disclosure generally relates to automatic adjustments of an exposure setting for a camera. Removing blur, noise and compression artifacts from images are longstanding problems in computational photography. Image degradation can be introduced from several sources, including when the photographer or the autofocus system incorrectly sets the focus (out-of-focus), or when the relative motion between the camera and the scene is faster than the shutter speed (motion blur). Additionally, even in ideal acquisition conditions, there can be an intrinsic camera blur due to sensor resolution, light diffraction, lens aberrations, and anti-aliasing filters. Similarly, image noise is intrinsic to the capture of a discrete number of photons (shot-noise), and the analog-digital conversion and processing (read out noise). In general, media content, such as images or video, are compressed, such as by using JPEG compression, before storage or transmission. Such compression can also degrade the quality of the media content by introducing artifacts.

Exposure refers to an amount of light per unit area reaching an electronic image sensor, as determined by one or more exposure parameters such as shutter speed, lens aperture, and scene luminance. By automatically adjusting exposure, a media content capturing device may improve the quality of generated images. For example, a media content capturing device may be configured to reduce blur, noise, compression artifacts, and so forth, to create sharp images. In some aspects, mobile devices may be configured with these features so that media content can be enhanced in real-time. In some instances, media content may be automatically enhanced by the mobile device. Also, for example, an encoder bitrate for auto exposure factorization can be dynamically adjusted. The sensitivity based on the bitrate configured at the encoder can be dynamically distributed, for example, by balancing changes in exposure time and digital gain, thereby resulting in increased visual quality. Also, for example, pre-existing images in a user's image library can be enhanced based on techniques described herein.

In one aspect, a computer-implemented method is provided. The method involves determining, by a media content processing component for processing media content, an exposure time, a digital gain, and a bitrate for processing the media content. The method also involves adjusting, based on the bitrate, an amount of motion blur, a level of image noise, or both, by updating one or more of the exposure time or the digital gain, wherein the adjusting, when applied to the media content, reduces one or more image degradations associated with the media content. The method additionally involves processing the media content based on the one or more of the updated exposure time or the updated digital gain.

In another aspect, a computing device includes one or more processors and data storage having computer-executable instructions stored thereon. When executed by the one or more processors, instructions cause the computing device to carry out operations comprising: determining, by a media content processing component for processing media content, an exposure time, a digital gain, and a bitrate for processing the media content; adjusting, based on the bitrate, an amount of motion blur, a level of image noise, or both, by updating one or more of the exposure time or the digital gain, wherein the adjusting, when applied to the media content, reduces one or more image degradations associated with the media content; and processing the media content based on the one or more of the updated exposure time or the updated digital gain.

In a further aspect, a system includes means for determining, by a media content processing component for processing media content, an exposure time, a digital gain, and a bitrate for processing the media content; means for adjusting, based on the bitrate, an amount of motion blur, a level of image noise, or both, by updating one or more of the exposure time or the digital gain, wherein the adjusting, when applied to the media content, reduces one or more image degradations associated with the media content; and means for processing the media content based on the one or more of the updated exposure time or the updated digital gain.

In another aspect, an example computer readable medium comprises program instructions that are executable by a processor to perform operations comprising determining, by a media content processing component for processing media content, an exposure time, a digital gain, and a bitrate for processing the media content; adjusting, based on the bitrate, an amount of motion blur, a level of image noise, or both, by updating one or more of the exposure time or the digital gain, wherein the adjusting, when applied to the media content, reduces one or more image degradations associated with the media content; and processing the media content based on the one or more of the updated exposure time or the updated digital gain.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE FIGURES

FIG. 1 illustrates a computing device, in accordance with example embodiments.

FIG. 2 is a block diagram of a media content processing pipeline, according to example embodiments.

FIG. 3 is another block diagram of a media content processing pipeline, according to example embodiments.

FIG. 4 is a block diagram illustrating an example encoder and decoder of a camera application, according to example embodiments.

FIG. 5 is a block diagram illustrating a detailed view of an example encoder of a camera application, according to example embodiments.

FIG. 6 is a flowchart illustrating an example method, according to example embodiments.

### DETAILED DESCRIPTION

### Overview

As media content capturing devices, such as cameras, become more popular, they may be employed as standalone hardware devices or integrated into various other types of devices. For instance, still and video cameras are now regularly included in wireless communication devices (e.g., mobile phones), tablet computers, laptop computers, video game interfaces, home automation devices, and even automobiles and other types of vehicles. Also, for example, remote cameras (e.g., security cameras) in an ambient computing environment, such as those configured to communicate with a base computing device (e.g., a mobile phone, a remote server, a content sharing platform, etc.) are being increasingly used to monitor homes and businesses.

Examples described herein include methods and systems for exposure factorization in image and/or video processing by media content capturing devices. Exposure factorization generally considers factors such as motion, noise, flicker, and so forth for sensitivity distribution. In the event there is high motion in a scene, a lower exposure time may be used with a higher digital gain. In the event there is low motion, the exposure time may be extended to improve a signal-to-noise ratio (SNR). The noise considered for exposure factorization is generally on YUV images before encoding, or encoded videos with a fixed bitrate. Generally speaking, existing automatic exposure (AE) controls do not factor in a lower bitrate, or a change in bitrate during image capture, and/or display. In case of a lower bitrate and a high entropy scene, the lower bitrate results in the encoder having compromised details and/or texture. Accordingly, allowing lower exposure time and higher digital gain may result in encoding artifacts. For example, the level of image noise can be adjusted to be higher than a threshold noise level. Exposure control for a camera of a mobile device, such as a smartphone, can be configured to reduce such artifacts.

The term “bitrate” as used herein, generally refers to an amount of data captured and/or recorded per second by a media content capturing device. Generally speaking, a higher bitrate may result in improved image quality (e.g., color, and/or resolution). The term “exposure time” as used herein, generally refers to an amount of time the media content capturing device collects light. Exposure time may also be referred to as shutter speed. For example, the exposure time can be the amount of time a digital sensor of the media content capturing device is exposed to light by a shutter. Generally speaking, in brightly lit environments, a shorter exposure time is optimal to avoid over-exposing the digital sensor. Correspondingly, in dimly lit environments, a longer exposure time is optimal to avoid under-exposing the digital sensor. Exposure time is measured in microseconds (μs). Increased exposure time may cause motion blur in images where motion occurs.

The term “digital gain” as used herein, generally refers to an amplification factor applied to a digital signal generated by the digital sensor. Digital gain can be measured in decibels (dB). An increase in the digital gain can result in increased brightness for the media content, but may also introduce noise in the media content.

When a mobile computing device user captures media content, the resulting image may have one or more image degradations due to motion blur, image compression, noise, and so forth. The term “image degradation” as used herein, generally refers to any factor that affects a sharpness of the media content, such as, for example, a clarity of the media content with respect to quantitative image quality parameters such as contrast, focus, and so forth. In some embodiments, the one or more image degradations may include one or more of a motion blur, an image noise, or a compression artifact.

The term “motion blur” as used herein, generally refers to a perceived image degradation that causes one or more objects in the media content to appear vague, and/or indistinct due to a motion of a camera capturing the media content, a motion of the one or more objects, or a combination of the two. In some examples, a motion blur may be perceived as streaking or smearing in the media content. Also, for example, for videos, a motion blur may cause an appearance of blocks in a displayed image due to different bitrates. In some embodiments, motion between sequential frames in image data may be evaluated (e.g., by measuring pixel motion across frames). Evaluating motion in the image data may further involve determining a motion mean and/or motion variance over a time window.

The term “image noise” as used herein, generally refers to a degradation factor that causes the media content to appear to have artifacts (e.g., specks, color dots, and so forth) resulting from a lower signal-to-noise ratio (SNR). For example, an SNR below a certain desired threshold value may cause image noise. In some examples, image noise may occur due to an image sensor, or a circuitry in a camera. Also, for example, image noise may be introduced during compression of an image and/or video by an encoder. Such encoder induced noise may be determined by analyzing the media content prior to and after encoding. The term “image compression artifact” as used herein, generally refers to a degradation factor that results from lossy image compression. For example, image data may be lost during compression, thereby resulting in visible artifacts in a decompressed version of the media content.

For a video call and/or a livestream, where a consumer of the video or the livestream views the video without pausing, motion blur may be less perceptible relative to an observable image artifact resulting from noise and/or a lower bitrate. In the event the encoder encodes video frames at a lower bitrate for auto exposure factorization, there may be a resultant quality loss and/or an introduction of artifacts. As such, an image-processing-related technical problem arises that involves removing the one or more image degradations to generate a sharp image. By dynamically changing the sensitivity distribution based on the bitrate, the overall objective and/or subjective quality of the image, and/or video may be improved.

As such, the herein-described techniques can improve media content by applying more desirable automatic exposure settings to the media content, thereby enhancing their actual and/or perceived quality. Enhancing the actual and/or perceived quality of the media content can provide user experience benefits based on an improved aesthetic quality of their media content. These techniques are flexible, and so can apply a wide variety of media content.

### Example Devices

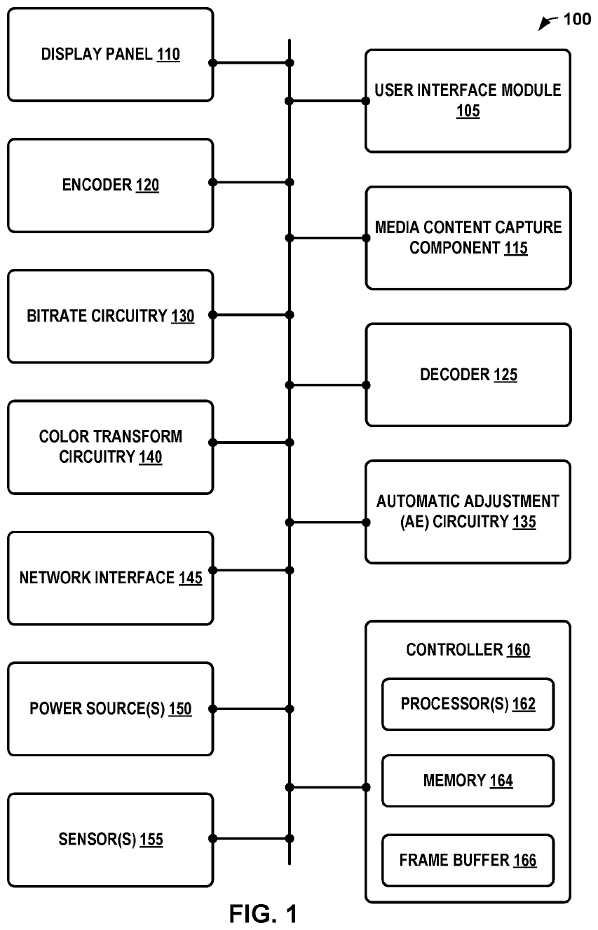

FIG. 1 illustrates computing device 100, in accordance with example embodiments. Computing device 100 includes user interface module 105, display panel 110, media content capture component 115, encoder 120, decoder 125, bitrate circuitry 130, automatic exposure (AE) circuitry 135, color transform circuitry 140, network interface 145, power source(s) 150, sensor(s) 155, and controller 160. In some examples, computing device 100 may take various forms including, but not limited to, a mobile phone, a standalone camera (e.g., a DSLR, point-and-shoot camera, camcorder, or cinema camera), tablet computer, laptop computer, desktop computer, server system, cloud-based computing device, a wearable computing device, or a network-connected home appliance or consumer electronic device, among other possibilities.

User interface module 105 can be operable to send data to and/or receive data from external user input/output devices. For example, user interface module 105 can be configured to send and/or receive data to and/or from user input devices such as a touch screen, a computer mouse, a keyboard, a keypad, a touch pad, a trackball, a joystick, a voice recognition module, and/or similar devices. User interface module 105 can also be configured to provide output to user display devices, such as display panel 110. In some examples, user interface module 105 can be used to provide a graphical user interface (GUI) for utilizing computing device 100.

Display panel 110 may be configured to provide output signals to a user by way of one or more screens (including touch screens), cathode ray tubes (CRTs), liquid crystal displays (LCDs), light emitting diodes (LEDs), organic LEDs (OLEDs), displays using digital light processing (DLP) technology, printers, light bulbs, and/or other similar technologies, either now known or later developed. Display panel 110 may also be configured to generate audible outputs, such as with a speaker, speaker jack, audio output port, audio output device, earphones, and/or other similar devices. Display panel 110 may be further configured with one or more haptic components that can generate haptic outputs, such as vibrations and/or other outputs detectable by touch and/or physical contact with computing device 100.

Display panel 110 may be configured to provide visual output at a given brightness level. The brightness level may be determined as a percentage of a maximum brightness level. In some examples, display panel 110 may be configured to automatically adjust its brightness level based on environmental brightness and/or other factors. In example embodiments, display panel 110 is configured to be a color display utilizing a plurality of color channels for generating images. For example, display panel 110 may utilize red, green, and blue (RGB) color channels, or cyan, magenta, yellow, and black (CMYK) color channels, among other possibilities. In some embodiments, display panel 110 is configured to adjust gamma characteristics for each of the color channels of display panel 110. Also, for example, display panel 110 may be configured to adjust color characteristics for each of the color channels of display panel 110.

In some embodiments, display panel 110 may include a plurality of pixels disposed in a pixel array defining a plurality of rows and columns. For example, if display panel 110 had a resolution of 1024×600, each column of the array may include 600 pixels and each row of the array may include 1024 groups of pixels, with each group including a red, blue, and green pixel, thus totaling 3072 pixels per row. In example embodiments, the color of a particular pixel may depend on a color filter that is disposed over the pixel.

In example embodiments, display panel 110 may receive image data from controller 160 and correspondingly send signals to its pixel array in order to display the image data. For example, display panel 110 may provide such image data as a display, such as an image, a background, a wallpaper, a user interface, one or more virtual objects, scrolling, a video, a home screen, a lock screen, a menu, an application, games, and so forth. To send image data to display panel 110, controller 160 may first convert a digital image into numerical data that can be interpreted by display panel 110. For instance, a digital image may contain various image pixels that correspond to respective pixels of display panel 110. Each pixel of the digital image may have a numerical value that represents the luminance (e.g., brightness or darkness) of the digital image at a particular spot. These numerical values may be referred to as “gray levels.” The number of gray levels may depend on the number of bits used to represent the numerical values. For example, if 8 bits were used to represent a numerical value, display panel 110 may provide 256 gray levels, with a numerical value of 0 corresponding to full black and a numerical value of 255 corresponding to full white. As a more specific example, controller 160 may provide to display panel 110 a digital image stream containing 24 bits, with 8 bits corresponding to a gray level for each of the red, green, and blue color channels of a pixel group.

Media content capture component 115 can include one or more media content capturing devices, such as still and/or video cameras, equipped to capture light and record the captured light in one or more images (or image frames for videos); that is, media content capture component 115 can generate image(s) of captured light. The one or more images can be one or more still images and/or one or more images utilized in video imagery. Media content capture component 115 can capture light and/or electromagnetic radiation emitted as visible light, infrared radiation, ultraviolet light, and/or as one or more other frequencies of light. Media content capture component 115 may include one or more lenses, lens motors, light sensors, hardware processors, and/or software for utilizing hardware of media content capture component 115 and/or for communicating with controller 160.

In example embodiments, each image frame captured by media content capture component 115 may be associated with a quality measure. This quality measure may be a quantitative metric that is calculated based on the amount of motion blur of the captured image frame, the overall focus of the captured image frame, and/or the exposure of the captured image frame, among other possibilities. In some implementations, the quality measure for a captured image frame may be computationally biased to allocate greater weight to pixels that are located within the regions of interest disposed within the captured image frame. For instance, the quality measure for an image frame with underexposed regions of interest but properly exposed background objects may be lower than the quality measure for an image frame with properly exposed regions of interest but underexposed background objects.

Encoder 120 can include circuitry to perform image and/or video compression to convert an image and/or video to a compressed format, such as JPEG. For example, one or more blocks of pixels may be compressed with a compression algorithm, such as, for example, a lossy image compression algorithm. Encoder 120 can include circuitry to send the compressed image and/or video to another device via a network interface, such as, for example, network interface 145. In some embodiments, encoder 120 can include a JPEG encoder, such as a non-color managed JPEG encoder, a color managed JPEG encoder, and/or a HDR encoder.

Decoder 125 can include circuitry to perform image and/or video decompression to convert an image and/or video from a compressed format, such as JPEG, to an uncompressed format, such as bitmap. For example, one or more blocks of pixels may be decompressed with a decompression algorithm, such as, for example, baseline decoding. Decoder 125 can include circuitry to receive the decompressed image and/or video from another device via a network interface, such as, for example, network interface 145. In some embodiments, decoder 125 can include a JPEG decoder, such as a non-color managed JPEG decoder, a color managed JPEG decoder, and a HDR decoder.

AE circuitry 135 can include circuitry to perform one or more automatic adjustments to the exposure settings for image and/or video processing. AE circuitry 135 may be configured to automatically adjust exposure time based on environmental lighting and/or other factors. For example, an automatic exposure function can be used to set an aperture of a lens of the camera, analog and/or digital gain of the camera, and/or a shutter speed of the camera prior to or during image capture. Image data from AE circuitry 135 may be provided for display on display panel 110 in the form of an image or video camera preview mode.

Color transform circuitry 140 can include circuitry to perform a color transformation, and/or an inverse of a color transformation. For example, each pixel of an image can be associated with a vector of three values (e.g., corresponding to red, green, blue (RGB) components). Generally, each input image and output image is associated with a vector color of color components. Color components can also be described as a linear transformation of RGB, such as, for example, YUV (Y for luminance, and U, V for chrominance), CMY (for Cyan, Magenta, and Yellow), and so forth.

Network interface 145 can include one or more wireless interfaces and/or wireline interfaces that are configurable to communicate via a network. Wireless interfaces can include one or more wireless transmitters, receivers, and/or transceivers, such as a Bluetooth™ transceiver, a Zigbee® transceiver, a Wi-Fi™ transceiver, a WiMAX™ transceiver, and/or other similar types of wireless transceivers configurable to communicate via a wireless network. Wireline interfaces can include one or more wireline transmitters, receivers, and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network.

In some embodiments, network interface 145 can be configured to provide reliable, secured, and/or authenticated communications. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information such as cyclic redundancy check (CRC) and/or parity check values). Communications can be made secure (e.g., be encoded or encrypted) and/or decrypted/decoded using one or more cryptographic protocols and/or algorithms, such as, but not limited to, Data Encryption Standard (DES), Advanced Encryption Standard (AES), a Rivest-Shamir-Adelman (RSA) algorithm, a Diffie-Hellman algorithm, a secure sockets protocol such as Secure Sockets Layer (SSL) or Transport Layer Security (TLS), and/or Digital Signature Algorithm (DSA). Other cryptographic protocols and/or algorithms can be used as well or in addition to those listed herein to secure (and then decrypt/decode) communications.

Power source(s) 150 can be configured to supply power to various components of computing device 100. Power source(s) 150 may include a hydraulic system, electrical system, batteries, or other types of power sources. Some components of computing device 100 may each connect to a different power source, may be powered by the same power source, or be powered by multiple power sources. Power source(s) 150 may charge using various types of charging, such as wired connections to an outside power source, wireless charging, combustion, or other examples.

Sensor(s) 155 can be configured to measure conditions in an environment of computing device 100 and provide data about that environment. For example, sensor(s) 155 can include one or more of: (i) an identification sensor to identify other objects and/or devices, such as, but not limited to, a Radio Frequency Identification (RFID) reader, proximity sensor, one-dimensional barcode reader, two-dimensional barcode (e.g., Quick Response (QR) code) reader, and a laser tracker, where the identification sensors can be configured to read identifiers, such as RFID tags, barcodes, QR codes, and/or other devices and/or object configured to be read and provide at least identifying information; (ii) sensors to measure locations and/or movements of computing device 100, such as, but not limited to, a tilt sensor, a gyroscope, an accelerometer, a Doppler sensor, a Global Positioning System (GPS) device, a sonar sensor, a radar device, a laser-displacement sensor, and a compass; (iii) an environmental sensor to obtain data indicative of an environment of computing device 100, such as, but not limited to, an infrared sensor, an optical sensor, a light sensor, a biosensor, a capacitive sensor, a touch sensor, a temperature sensor, a wireless sensor, a radio sensor, a movement sensor, a microphone, a sound sensor, an ultrasound sensor, and/or a smoke sensor; and (iv) a force sensor to measure one or more forces (e.g., inertial forces and/or G-forces) acting about computing device 100, such as, but not limited to one or more sensors that measure: forces in one or more dimensions, torque, ground force, friction, and/or a zero moment point (ZMP) sensor that identifies ZMPs and/or locations of the ZMPs. Many other examples of sensor(s) 155 are possible as well.

Controller 160 may include one or more processor(s) 162, memory 164, and frame buffer 166. Processor(s) 162 can include one or more general purpose processors and/or one or more special purpose processors (e.g., display driver integrated circuit (DDIC), digital signal processors (DSPs), tensor processing units (TPUs), graphics processing units (GPUs), application specific integrated circuits (ASICs), etc.). Processor(s) 162 may be configured to execute computer-readable instructions that are contained in memory 164 and/or other instructions as described herein.

Memory 164 may include one or more non-transitory computer-readable storage media that can be read and/or accessed by processor(s) 162. The one or more non-transitory computer-readable storage media can include volatile and/or non-volatile storage components, such as optical, magnetic, organic, or other memory or disc storage, which can be integrated in whole or in part with at least one of processor(s) 162. In some examples, memory 164 can be implemented using a single physical device (e.g., one optical, magnetic, organic or other memory or disc storage unit), while in other examples, memory 164 can be implemented using two or more physical devices. In some embodiments, memory 164 can include frame buffer 166.

Frame buffer 166 can be a portion of memory that can drive the display of an image or a video. In some embodiments, frame buffer 166 can be a portion of memory that can drive encoding of an image or a video. For example, frame buffer 166 can include data related to pixels in an image or a frame of a video. In some embodiments, the data can include color values for pixels in the image. In some embodiments, frame buffer 166 can include circuitry to convert an in-memory bitmap of the image to a format that can be displayed by display panel 110. In some embodiments, frame buffer 166 can include circuitry to convert an in-memory raw image to a bitmap of the image, for storage or transmission. Generally, an amount of memory in frame buffer 166 can depend on factors such as a color depth, a resolution, and so forth, for the image or video.

In example embodiments, processor(s) 162 are configured to execute instructions stored in memory 164 to carry out operations.

The operations include determining, by a media content processing component for processing media content, an exposure time, a digital gain, and a bitrate for processing the media content; adjusting, based on the bitrate, an amount of motion blur, a level of image noise, or both, by updating one or more of the exposure time or the digital gain, wherein the adjusting, when applied to the media content, reduces one or more image degradations associated with the media content; and processing the media content based on the one or more of the updated exposure time or the updated digital gain.

The term “adjusting” as used herein, generally refers to striking a balance between two or more competing image characteristics. For example, an adjustment may include trading off motion blur for image noise, or vice versa. Even though low motion blur and low noise may be desirable qualities in an image, a reduced bitrate may introduce on or more perceptible image artifacts. In such situations, low motion blur and/or low noise may be traded-off to reduce the image artifacts and achieve better perceptible quality of the media content. In some embodiments, low motion blur may be traded-off for high motion blur. Also, for example, a low level of image noise may be traded-off for a high level of image noise. For example, in some low bitrate situations, higher motion blur may be traded-off for lower image noise. As described herein, the adjusting (or the trade-off) may be dynamically determined based on the bitrate, which can depend on a type of device, a type of image application program (e.g., different social media platforms, streaming media services), a type of media content capturing device (e.g., sophisticated automatic exposure settings), network characteristics (e.g., bandwidth, channel, encryption, cellular, or Wi-Fi or near-field), a type of function (e.g., higher resolution, higher texture, compression schemes), and so forth.

### Exposure Factorization

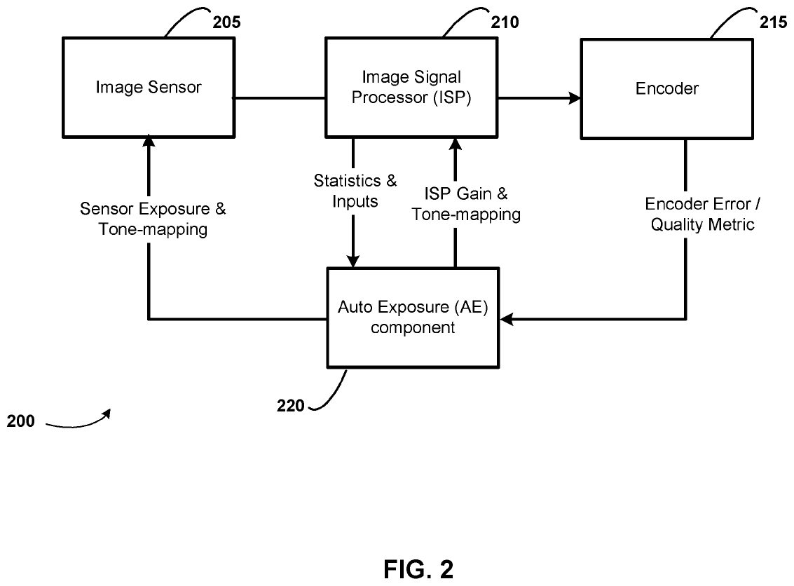

FIG. 2 is a block diagram 200 of a media content processing pipeline, according to example embodiments. Image sensor 205 may capture a digital image. In some embodiments, image sensor 205 may be a complementary metal oxide semiconductor (CMOS) sensor. Image signal processor (ISP) 210 may convert the media content from image sensor 205 into a digital signal. ISP 210 may factor in feedback received from the automatic exposure (AE) component 220, including ISP gain, tone mapping, and so forth. ISP 210 may also provide statistics related to an image or video, inputs related to the camera application (e.g., user inputs related to focusing, brightness, regions of interest, and so forth), to AE component 220. ISP 210 may then provide the digital signal to encoder 215.

In some embodiments, an automatic exposure adjustment may be performed based on the feedback loop from the encoder 215 based on determining an error between frames before and after encoding is performed. In some embodiments, the automatic exposure adjustment may be performed based on the bitrate. The error may be determined based on a first visual noise measurement associated with the frame prior to encoding by encoder 215 as an image without noise, and a second visual noise measurement associated with the frame after encoding by encoder 215 as an image with noise. The noise comprises one or more encoding artifacts. The visual noise measurements may be based on a metric such as mean squared error. Based on this error metric as a feedback, AE component 220 can be configured to increase the exposure time when the error exceeds an error threshold. In turn, AE component 220 may provide sensor exposure data and tone-mapping information to image sensor 205.

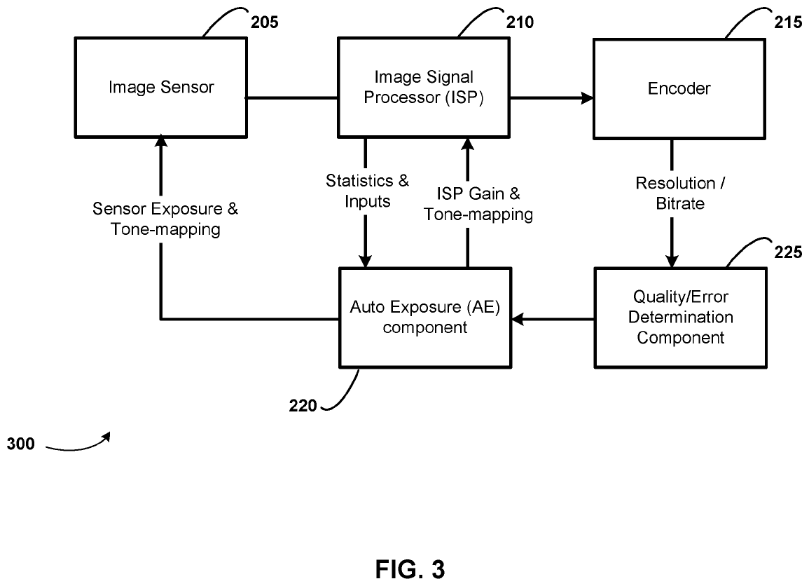

FIG. 3 is another block diagram 300 of a media content processing pipeline, according to example embodiments. As illustrated, block diagram 300 may share one or more blocks with FIG. 2, such as image sensor 205, ISP 210, encoder 215, and AE component 220. FIG. 3 illustrates a scenario where instead of receiving feedback from encoder 215 (as described with reference to FIG. 2), the error metric may be interpolated from a static mapping generated based on past observations. For example, quality and/or error determination component 225 may receive information related to image resolution and bitrate from encoder 215, determine the error, and provide such information to AE component 220.

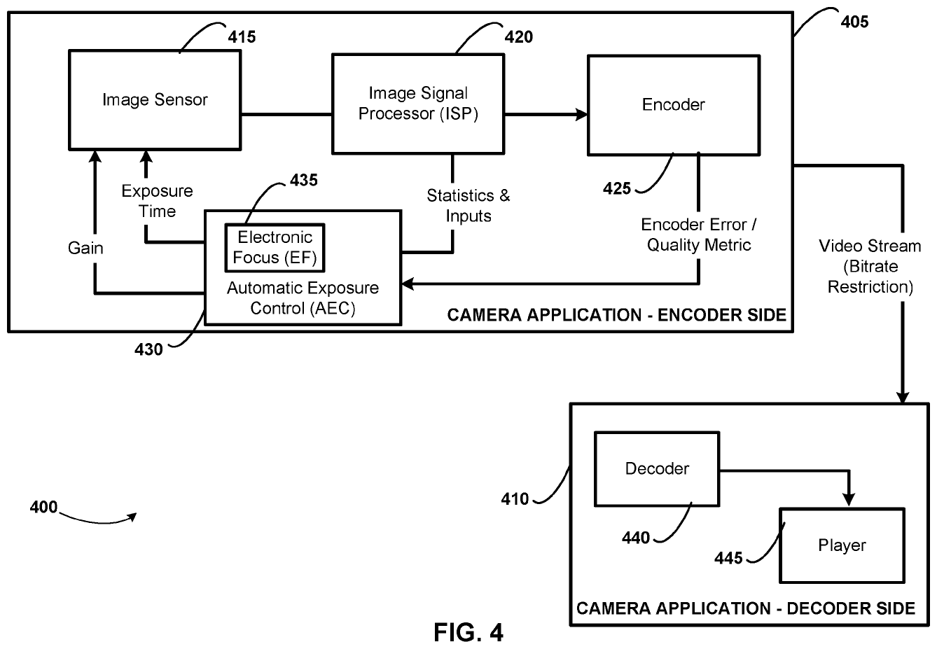

FIG. 4 is a block diagram 400 illustrating an example encoder and decoder of a camera application, according to example embodiments. For example, a camera application may include an encoder side application 405 and a decoder side application 410. The encoder side application 405 can be configured to perform operations including encoding images with encoder 425. The decoder side application 410 can be configured to perform operations including decoding images with decoder 440.

Image sensor 415, ISP 420, encoder 425, and automatic exposure control (AEC) 430 may share one or more aspects in common with image sensor 205, ISP 210, encoder 215, and AE component 220, respectively of FIGS. 2 and 3. As illustrated, AEC 430 may include electronic focus (EF) 435. In some embodiments, based on data received from image sensor 415, ISP 420 may determine an exposure time, a digital gain, and a bitrate for processing the media content captured by image sensor 415. ISP 420 may determine a trade-off between motion blur and image noise to reduce one or more image degradations associated with the media content. Based on the determined trade-off, AEC 430 may determine the exposure time to compensate for the motion blur, the digital gain to compensate for the image noise, or both. Also, for example, encoder 425 may provide an encoder error and/or image quality metric to AEC 430, and the exposure time and/or the digital gain may be updated to account for such encoder errors. Finally, AEC 430 may adjust, responsive to the updating, one or more automatic exposure settings for the media content processing component, and provide the adjusted automatic exposure settings to image sensor 415. Image sensor 415 may, in turn, capture media content based on the adjusted automatic exposure settings. In some embodiments, the adjusted automatic exposure settings may be applied to a preview of the media content displayed in a viewfinder for the media content capturing device.

The encoder side application 405 may encode a captured media content based on the automatic exposure settings. In some embodiments, the captured media content may be stored at the media content capturing device. Also, for example, the captured and encoded media content may be transmitted to the decoder side application 410. In some embodiments, the transmission may occur over a communications network. When the communications network has a high bitrate, an encoded media content may be transmitted with low motion blur and low image noise. However, as the network bandwidth gets restricted, a quality of the transmitted media content may be degraded. Generally, when a video is encoded and transmitted over a network, a lower exposure time is applied to reduce the amount of motion blur. However, when such a video is decoded by a decoder and displayed, the resulting video may be displayed with artifacts, such as blocks, in the video frames.

For example, a video with a higher level of image noise may be encoded and transmitted over a network with a lower bandwidth. However, the encoded video, when decoded and displayed, may have image degradations such as blocks. Accordingly, for a lower bitrate, instead of reducing the amount of motion blur, it may be preferable to encode the video with higher motion blur and lower noise (i.e., lower digital gain). This allows for the decoder to decode and display the video without the blocks. As described previously, motion blur is less perceptible in a video or a livestream. Therefore, a perceptible quality of the video is improved.

In some embodiments, the media content may include texture, and when encoded over a lower bitrate, image noise may be reduced, thereby removing the texture, and rendering the media content as flat. Therefore, it may be preferable to increase image noise (i.e., increase digital gain) and increase exposure time to allow some motion blur. Generally speaking, a lower digital gain corresponds to a decreased level of image noise and an increased amount of motion blur, whereas a higher digital gain corresponds to an increased level of image noise and a decreased amount of motion blur. Accordingly, the adjusting or trade-off process seeks an optimal balance between the motion blur and the image noise by calibrating the exposure time and the digital gain.

The decoder side application 410 may include a decoder 440 and a player 445. For example, decoder side application 410 may receive an encoded media content, decode it, and provide it to player 445. Generally, an encoded video with low motion blur and low image noise requires a higher bitrate for transmission. In some embodiments, when an encoded video with low motion blur and low image noise is transmitted over a network with limited bandwidth, decoder 440 is not able to decode the video accurately, and artifacts such as blocks may appear in the decoded video displayed by player 445. Accordingly, encoder 425, in response to an indication of a reduced bitrate, may determine an adjustment for an amount of motion blur or a level of image noise and apply that adjustment to the encoding process. For example, encoder 425 may decrease the digital gain during encoding, and this may result in lower noise and higher motion blur. However, when decoder 440 decodes the compressed video, the artifacts related to blocks are reduced, providing a smoother viewing experience to a viewer viewing the decompressed video as provided by player 445. In some embodiments, a decompression level of the media content may be determined based on a performance characteristic of decoder 440. Accordingly, the bitrate may be adjusted responsive to the determining of the decompression level. For example, although not shown in FIG. 4, decoder side application 410 may include a bitrate adjustment component that can be configured to adjust the bitrate based on one or more of the decompression level, a network strength, a level of compression of a received media content, and so forth.

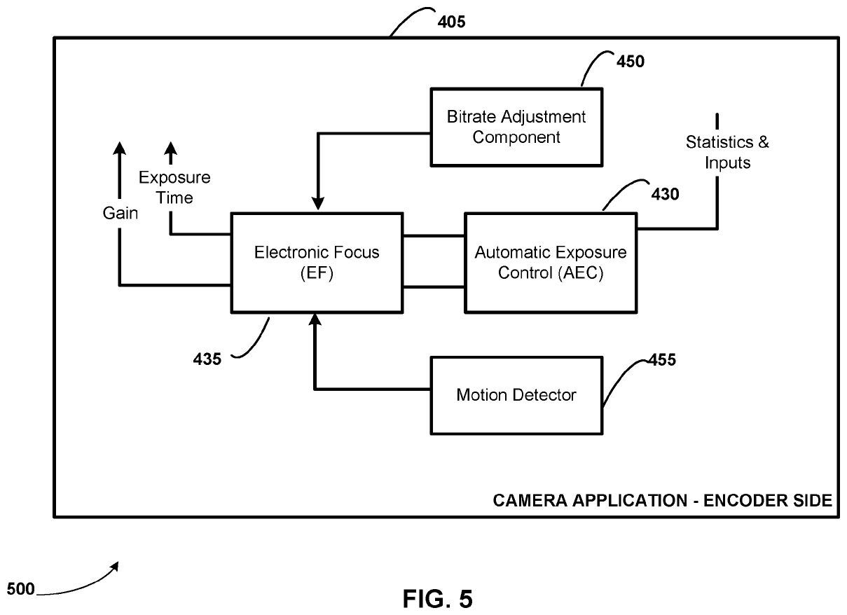

FIG. 5 is a block diagram 500 illustrating a detailed view of an example encoder of a camera application, according to example embodiments. For example, an exploded view of encoder side application 405 of FIG. 4 is illustrated. Encoder side application 405 may include bitrate adjustment component 450, motion detector 455, EF 435, and AEC 430. In some embodiments, AEC 430 and EF 435 may share one or more aspects in common with AEC 430 and EF 435 of FIG. 4.

In some embodiments, bitrate adjustment component 450 may adjust the bitrate. For example, bitrate adjustment component 450 may determine that the amount of motion blur is higher than a threshold blur level. Accordingly, bitrate adjustment component 450 may increase the bitrate. As another example, bitrate adjustment component 450 may determine that the level of image noise is higher than a threshold noise level. Accordingly, bitrate adjustment component 450 may decrease the bitrate. EF 435 may then automatically adjust the amount of motion blur and/or level of image noise.

In some embodiments, motion detector 455 may detect motion in a video by analyzing a sequence of frames. For example, an optical flow may be determined based on motion vectors from a plurality of successive video frames. Motion detector 455 may detect motion based on the optical flow. In some embodiments, a certain amount of motion blur may be preferable to image noise. In other embodiments, reducing the level of image noise may be more preferable to motion blur. More specifically, motion between sequential frames in the image data may be evaluated (e.g., by measuring pixel motion across frames). Evaluating motion in the image data may further involve determining a motion mean and/or motion variance over a time window.

### Example Methods of Operation

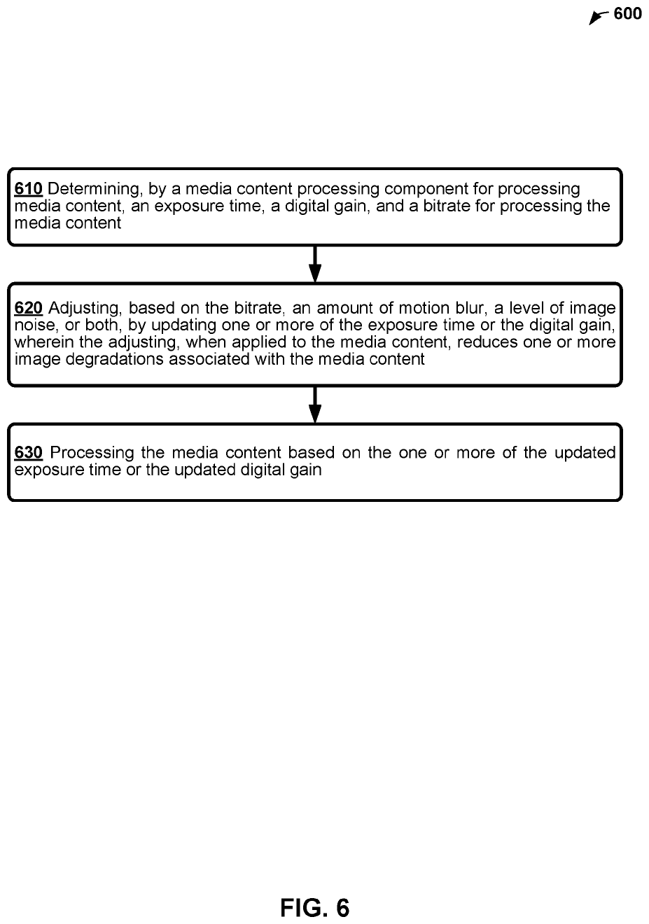

FIG. 6 is a flowchart illustrating an example method 600, according to example embodiments. Method 600 can be executed by a computing device, such as computing device 100. Method 600 can begin at block 610, where the method involves determining, by a media content processing component for processing media content, an exposure time, a digital gain, and a bitrate for processing the media content.

At block 620, the method also involves adjusting, based on the bitrate, an amount of motion blur, a level of image noise, or both, by updating one or more of the exposure time or the digital gain, wherein the adjusting, when applied to the media content, reduces one or more image degradations associated with the media content.

At block 630, the method additionally involves processing the media content based on the one or more of the updated exposure time or the updated digital gain.

In some embodiments, the bitrate may be below a bitrate threshold, and the adjusting includes decreasing the amount of motion blur and adjusting the level of image noise to be higher than a threshold noise level. The updating involves decreasing the exposure time.

In some embodiments, the bitrate may be above a bitrate threshold, and the adjusting includes increasing the amount of motion blur. The updating involves increasing the exposure time.

In some embodiments, the media content processing component may be a part of a computing device (such as computing device 100). The computing device may include an application program configured to run on the computing device. For example, the application program may relate to a social media platform for sharing images and/or videos. Generally, such application programs may be configured to operate at a lower bitrate. Some embodiments involve determining that the application program is configured to encode the media content with a bitrate below a bitrate threshold. In such embodiments, the adjusting includes increasing the amount of motion blur and decreasing the level of image noise. The updating involves increasing the exposure time and decreasing the digital gain. Generally, a bitrate corresponding to the application program may be determined, or a compression level associated with the application program may be determined, and the adjusting between an increased amount of motion blur and a decreased level of image noise may be based on the determined bitrate, and/or the level of compression.

Some embodiments involve determining, based on a network characteristic of a communication network being below a threshold network characteristic, that the bitrate is below a bitrate threshold. In such embodiments, the adjusting includes increasing the amount of motion blur and decreasing the level of image noise. The updating involves increasing the exposure time and decreasing the digital gain. Such embodiments involve transmitting, over the communication network, the encoded image based on the updated exposure time and the updated digital gain. The threshold network characteristic is a network bandwidth. For example, a lower bandwidth may result in a lower bitrate for encoding, and a higher bandwidth may result in a higher bitrate for encoding.

In some embodiments, the communication network may be a cellular network, and the network characteristic of the communication network may be a distance of the media content processing component from a cellular base station associated with the cellular network. For example, as the distance from the cellular base station increases, there can be a reduction in network capacity, resulting in a reduced bitrate and a lower SNR. Consequently, it may not be feasible to transmit a high quality image or video. Also, for example, as the distance from the cellular base station decreases, there can be an increase in network capacity, resulting in an increased bitrate.

Some embodiments involve determining that the bitrate is likely to cause motion blur in a video to be displayed, and the adjusting includes increasing the amount of motion blur and decreasing the level of image noise. The updating involves increasing the exposure time and decreasing the digital gain for the video.

In some embodiments, the one or more image degradations may be the motion blur. Such embodiments involve determining the amount of motion blur based on an optical-flow from successive frames of a video. Such embodiments also involve determining the amount of motion blur based on an environmental brightness level.

In some embodiments, the one or more image degradations may be the image noise including one or more of additive noise, signal dependent noise, or colored noise. In some embodiments, the image noise may result from encoding. As described an encoding error may be determined by comparing media content prior to encoding and media content after encoding. Some embodiments involve determining an error in the image noise based on a difference between a first noise level prior to encoding and a second noise level after encoding. The adjusting may be based on the determined error.

In some embodiments, the one or more image degradations may be a compression artifact. Such embodiments involve determining that an encoder performance indicates a compression level of the media content that is higher than a threshold capacity for network bandwidth. Such embodiments involve, responsive to the determining of the encoder performance, decreasing the digital gain.

Some embodiments involve determining, based on a decoder performance, a decompression level of the media content. Such embodiments involve adjusting the bitrate responsive to the determining of the decompression level.

Some embodiments involve determining that the level of image noise is higher than a threshold noise level. Such embodiments involve, responsive to the determining of the level of image noise, decreasing the bitrate.

Some embodiments involve determining that the amount of motion blur is higher than a threshold blur level. Such embodiments involve, responsive to the determining of amount of motion blur, increasing the bitrate.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as non-transitory computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software and/or hardware modules in the same physical device. However, other information transmissions may be between software modules and/or hardware modules in different physical devices.

While various aspects and embodiments have been disclosed herein, other aspects and embodiments will be apparent to those skilled in the art. The various aspects and embodiments disclosed herein are provided for explanatory purposes and are not intended to be limiting, with the true scope being indicated by the following claims.

1. A computer-implemented method comprising:
determining, by a media content processing component for processing media content, an exposure time, a digital gain, and a bitrate for processing the media content;
adjusting, based on the bitrate, an amount of motion blur, a level of image noise, or both, by updating one or more of the exposure time or the digital gain, wherein the adjusting, when applied to the media content, reduces one or more image degradations associated with the media content, wherein the bitrate is below a bitrate threshold, wherein the adjusting comprises decreasing the amount of motion blur and adjusting the level of image noise to be higher than a threshold noise level, and wherein the updating comprises decreasing the exposure time; and
processing the media content based on the one or more of the updated exposure time or the updated digital gain.

2. (canceled)

3. The computer-implemented method of claim 1, wherein the bitrate is above a bitrate threshold, wherein the adjusting comprises increasing the amount of motion blur, and wherein the updating comprises increasing the exposure time.

4. The computer-implemented method of claim 1, wherein the media content processing component is a part of a computing device, and wherein the computing device comprises an application program configured to run on the computing device, and further comprising:
determining that the application program is configured to encode the media content with the bitrate below a bitrate threshold, and
wherein the adjusting comprises increasing the amount of motion blur and decreasing the level of image noise, and wherein the updating comprises increasing the exposure time and decreasing the digital gain.

5. The computer-implemented method of claim 1, further comprising:
determining, based on a network characteristic of a communication network being below a threshold network characteristic, that the bitrate is below a bitrate threshold, wherein the adjusting comprises increasing the amount of motion blur and decreasing the level of image noise, and wherein the updating comprises increasing the exposure time and decreasing the digital gain; and
transmitting, over the communication network, an encoded image based on the updated exposure time and the updated digital gain.

6. The computer-implemented method of claim 5, wherein the threshold network characteristic is a network bandwidth.

7. The computer-implemented method of claim 5, wherein the communication network is a cellular network, and wherein the network characteristic of the communication network is a distance of the media content processing component from a cellular base station associated with the cellular network.

8. The computer-implemented method of claim 1, further comprising:
determining that the bitrate is likely to cause motion blur in a video to be displayed, wherein the adjusting comprises increasing the amount of motion blur and decreasing the level of image noise, and wherein the updating comprises increasing the exposure time and decreasing the digital gain for the video; and
displaying the video based on the updated exposure time and the updated digital gain.

9. The computer-implemented method of claim 1, wherein the one or more image degradations comprise the motion blur.

10. The computer-implemented method of claim 9, further comprising:
determining the amount of motion blur based on an optical-flow from successive frames of a video.

11. The computer-implemented method of claim 9, further comprising:
determining the amount of motion blur based on an environmental brightness level.

12. The computer-implemented method of claim 1, wherein the one or more image degradations comprise the image noise comprising one or more of additive noise, signal dependent noise, or colored noise.

13. The computer-implemented method of claim 12, further comprising:
determining an error in the image noise based on a difference between a first noise level prior to encoding and a second noise level after encoding, and
wherein the updating is based on the determined error.

14. The computer-implemented method of claim 1, wherein the one or more image degradations comprise a compression artifact.

15. The computer-implemented method of claim 14, further comprising:
determining that an encoder performance indicates a compression level of the media content that is higher than a threshold capacity for network bandwidth; and
responsive to the determining of the encoder performance, decreasing the digital gain.

16. The computer-implemented method of claim 1, further comprising:
determining, based on a decoder performance, a decompression level of the media content; and
adjusting the bitrate responsive to the determining of the decompression level.

17. The computer-implemented method of claim 1, further comprising:
determining that the level of image noise is higher than a threshold noise level; and
responsive to the determining of the level of image noise, decreasing the bitrate.

18. The computer-implemented method of claim 1, further comprising:
determining that the amount of motion blur is higher than a threshold blur level; and
responsive to the determining of the amount of motion blur, increasing the bitrate.

19. A computing device, comprising:
one or more processors; and
data storage, wherein the data storage has stored thereon computer-executable instructions that, when executed by the one or more processors, cause the computing device to carry out operations comprising:
determining, by a media content processing component for processing media content, an exposure time, a digital gain, and a bitrate for processing the media content;
adjusting, based on the bitrate, an amount of motion blur, a level of image noise, or both, by updating one or more of the exposure time or the digital gain, wherein the adjusting, when applied to the media content, reduces one or more image degradations associated with the media content, wherein the bitrate is below a bitrate threshold, wherein the adjusting comprises decreasing the amount of motion blur and adjusting the level of image noise to be higher than a threshold noise level, and wherein the updating comprises decreasing the exposure time; and
processing the media content based on the one or more of the updated exposure time or the updated digital gain.

20. (canceled)

21. The computing device of claim 19, wherein the bitrate is above a bitrate threshold, wherein the adjusting comprises increasing the amount of motion blur, and wherein the operations for the updating comprise operations for increasing the exposure time.

22. The computing device of claim 19, wherein the computing device comprises an application program configured to run on the computing device, and the operations further comprising:
determining that the application program is configured to encode the media content with the bitrate below a bitrate threshold, and
wherein the adjusting comprises increasing the amount of motion blur and decreasing the level of image noise, and wherein the operations for the updating comprise operations for increasing the exposure time and decreasing the digital gain.

23. The computing device of claim 19, the operations further comprising:
determining, based on a network characteristic of a communication network being below a threshold network characteristic, that the bitrate is below a bitrate threshold, wherein the adjusting comprises increasing the amount of motion blur and decreasing the level of image noise, and wherein the operations for the updating comprise operations for increasing the exposure time and decreasing the digital gain; and
transmitting, over the communication network, an encoded image based on the updated exposure time and the updated digital gain.

24. The computing device of claim 19, the operations further comprising:
determining that the bitrate is likely to cause motion blur in a video to be displayed, wherein the adjusting comprises increasing the amount of motion blur and decreasing the level of image noise, and wherein the operations for the updating comprise operations for increasing the exposure time and decreasing the digital gain for the video; and
displaying the video based on the updated exposure time and the updated digital gain.

25. The computing device of claim 19, the operations further comprising:
determining that an encoder performance indicates a compression level of the media content that is higher than a threshold capacity for network bandwidth; and
responsive to the determining of the encoder performance, decreasing the digital gain.

26. The computing device of claim 19, the operations further comprising:
determining, based on a decoder performance, a decompression level of the media content; and
adjusting the bitrate responsive to the determining of the decompression level.

27. A non-transitory computer readable medium having program instructions stored thereon that are executable by a processor to perform operations comprising:
determining, by a media content processing component for processing media content, an exposure time, a digital gain, and a bitrate for processing the media content;
adjusting, based on the bitrate, an amount of motion blur, a level of image noise, or both, by updating one or more of the exposure time or the digital gain, wherein the adjusting, when applied to the media content, reduces one or more image degradations associated with the media content, wherein the bitrate is below a bitrate threshold, wherein the adjusting comprises decreasing the amount of motion blur and adjusting the level of image noise to be higher than a threshold noise level, and wherein the updating comprises decreasing the exposure time; and
processing the media content based on the one or more of the updated exposure time or the updated digital gain.
